(19) United States
(12) Patent Application Publication
(10) Pub. No.: US 2006/0010397 A1
(43) Pub. Date: Jan. 12, 2006

(54) System for locking the closure of windows

(75) Inventor: Patrick Justin Laffey, Cedar Park, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/887,523

(22) Filed: Jul. 8, 2004

(51) Int. Cl. G06F 3/00

(52) U.S. Cl. 715/808; 715/809

(57) ABSTRACT

Method, system and computer program product for controlling the closing of a window on a display screen in a data processing system. A system for controlling the closing of a window has a first functionality for locking a window against being closed by a single, user initiated closing action, and a second functionality for closing the locked window by a plurality of user initiated closing actions. Because a plurality of closing actions is required to close a window, the unintended closing of a window is substantially prevented.

### BACKGROUND OF THE INVENTION

1. Technical Field

The present invention relates generally to the data processing field and, more particularly, to a method, system and computer program product for controlling the closing of a window on a display screen in a data processing system.

2. Description of Related Art

A window is an enclosed area on a display screen in a data processing system within which data can be displayed or a program can be run. The display screen can display a single window, or the display screen can simultaneously display a plurality of windows, each running a different program or displaying different data.

A graphical user interface (GUI) enables a user to set the dimensions and positions of windows displayed on a display screen. A plurality of displayed windows can be positioned to be side-by-side or arranged to overlap one another. Overlapping windows, also called cascading windows, resemble a stack of paper lying one on top of another. The topmost window is displayed in full, while only portions of the underlying windows are visible. To enter input into a program of an underlying window of the overlapping windows, a user simply clicks on the desired window using a mouse, for example, to bring the desired window to the foreground.

In a Windows operating system, available from Microsoft Corporation, a window includes three small buttons at the upper right-hand corner of the window. By clicking on an appropriate one of the three buttons, the window can be minimized, zoomed or closed. Typically, the button closest to the upper right-hand corner of the window is the close button, and is clicked on to close the window.

It sometimes occurs that a user unintentionally closes a window that he intended to keep open. The unintentional closing of a window is especially common in situations in which a plurality of windows is simultaneously displayed on a display screen. Examples of such situations include:
1) A user is using a browser and most of the links on a certain webpage cause a new window to be created. The user clicks on the first link and it opens a new window. The user reads the new webpage and then clicks on the close button. This is done multiple times. The user then clicks on another link and a new webpage opens in the same window.

The user is usually unaware that a new window has not been created. The user then clicks on the close button, and this closes the main window with the inherent loss of data and history.
2) Two windows are open on a display screen.

A user is about to click on the close button on one window when another window grabs his attention because of an event change. The user accidentally clicks on the close button on the wrong window since the window has popped up to the foreground.
3) With multiple overlapping windows, the dimensions of the different windows sometimes do not match up precisely. A user intends to click the title bar on the topmost window, but misses by a couple of pixels. The user thus accidentally clicks outside the topmost window and clicks on the window directly underneath. Since the close button is usually in the same general area as the title bar, the underlying window can be accidentally closed.

The above and other situations that can result in the unintentional closing of a window can cause a user to lose data, past histories, time and patience.

Accordingly, it would be advantageous to provide a technique for controlling the closing of a window on a display screen in a data processing system to prevent an unintentional closing of the window.

### SUMMARY OF THE INVENTION

The present invention provides a method, system and computer program product for controlling the closing of a window on a display screen in a data processing system. A system for controlling the closing of a window includes a first functionality for locking a window against being closed by a single, user initiated closing action, and a second functionality for closing the locked window by a plurality of user initiated closing actions. Because a plurality of closing actions is required to close a locked window, the unintentional closing of a window is substantially prevented.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented;

FIG. 3 is a pictorial representation of a display screen displaying a plurality of windows to assist in explaining a preferred embodiment of the present invention;

FIG. 4 is a pictorial representation of a menu that may be opened on the display screen of FIG. 3 in accordance with a preferred embodiment of the invention;

FIG. 5 is a pictorial representation of a pop-*/up box that may appear on the display screen of FIG. 3 in accordance with a preferred embodiment of the invention;

FIG. 6 is a flowchart that illustrates a method for locking a window against being closed by a single, user initiated closing action in accordance with a preferred embodiment of the present invention; and

FIG. 7 is a flowchart that illustrates a method for closing a locked window by a plurality of user initiated closing actions in accordance with a preferred embodiment of the present invention.

### DETAILED DESCRIPTION OF THE PREFERRED EMBODIMENT

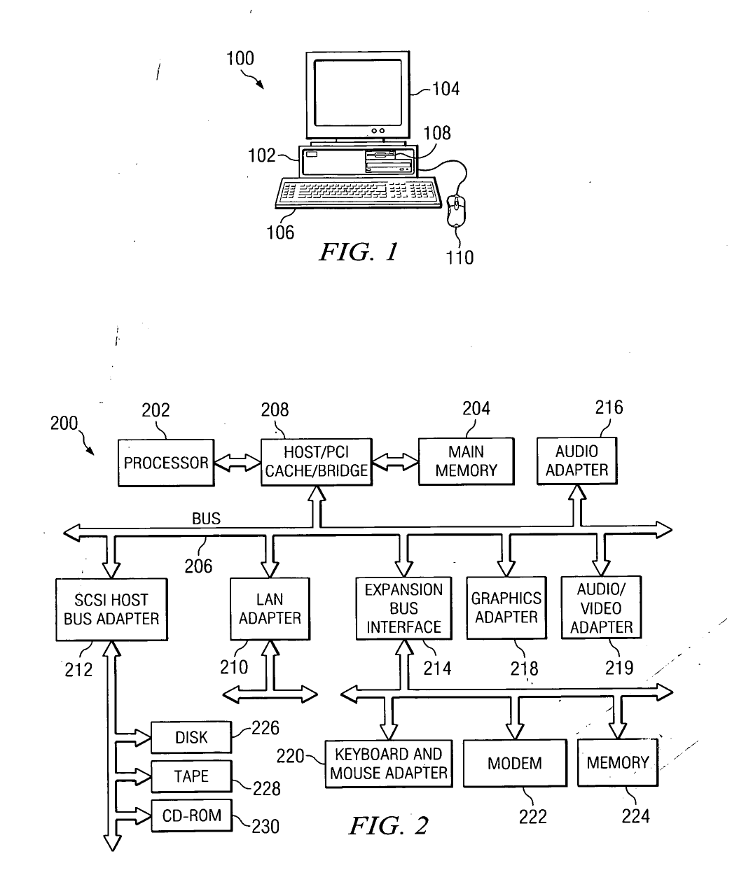

With reference now to the figures, FIG. 1, depicts a pictorial representation of a data processing system in which the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

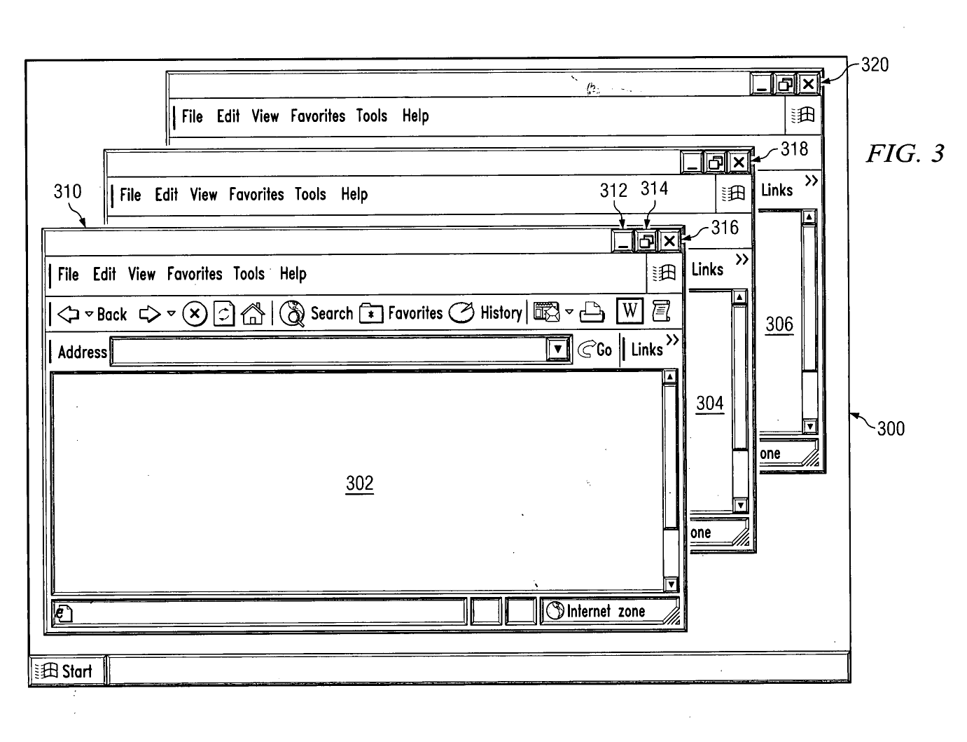

FIG. 3 is a pictorial representation of a display screen displaying a plurality of windows to assist in explaining a preferred embodiment of the present invention. The display screen is generally designated by reference number 300 and may, for example, be a display screen on display terminal 104 of computer 100 illustrated in FIG. 1.

Display screen 300 displays three windows 302, 304 and 306. The illustration of three windows is intended to be exemplary only, as display screen 300 may display one window or any desired plurality of windows without departing from the scope of the present invention. In addition, in FIG. 3, windows 302, 304 and 306 are shown as overlapping one another with window 302 being on top. This depiction is also intended to be exemplary only, as windows 302, 304 and 306 can be arranged in any desired manner on display screen 300.

As is known to those skilled in the art, a different program can be run or different data can be displayed within each of windows 302, 304 and 306. By simultaneously displaying a plurality of windows on display screen 300, a user can easily execute several programs. For example, to enter input into a particular program, the user simply clicks on a desired window using a mouse or the like, for example, mouse 110 in FIG. 1, to bring the desired window into the foreground.

Each of windows 302, 304 and 306 includes a title bar that extends along the upper edge of the window, and a set of three buttons at the upper right-hand corner of the window. Thus, window 302 includes title bar 310 extending along the upper edge of the window, and three buttons 312, 314 and 316 at the upper right-hand corner of the window. Windows 304 and 306 similarly include a title bar along their upper edge and three buttons at their upper right-hand corner.

Button 312 comprises a minimize button and carries indicia in the form of a dash, and button 314 comprises a zoom button and carries indicia in the form of one or two rectangles. Button 316 carries indicia in the form of an “X” and comprises a close button. By placing a cursor on close button 316 and clicking on the button, window 302 can be closed. Similarly, windows 304 and 306 can be closed by clicking on close buttons 318 and 320, respectively.

There are a number of situations in which a user might unintentionally close a window that he intended to keep open. For example, as shown in FIG. 3, close buttons 316, 318 and 320 of windows 302, 304 and 306, respectively, are quite near one another on display screen 300, and a user can accidentally position the cursor on the close button of the wrong window and close that window when the user intended to close another window. The unintentional closing of a window can result in the loss of data and past histories, and can be quite troublesome to the user.

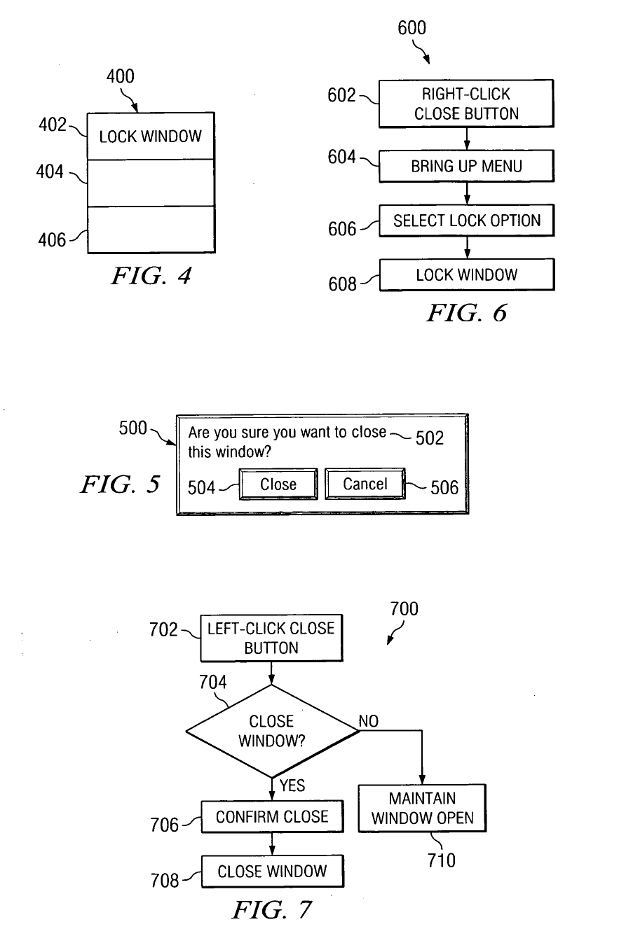

In accordance with a preferred embodiment of the present invention, a first functionality is provided in a data processing system for locking a window against being closed by a single, user initiated closing action; for example, by clicking on the close button of the window, to substantially prevent the unintentional closing of the window. The first functionality includes a menu that is brought up on display screen 300 by a user when the user wishes to lock a window against being closed by a single, user initiated closing action. FIG. 4 is a pictorial representation of a menu that may be opened on display screen 300 of FIG. 3 in accordance with a preferred embodiment of the invention. The menu is generally designated by reference number 400, and is brought up on display screen 300 by right-clicking on the close button of the window the user wishes to lock. For example, if a user wishes to lock window 302 in FIG. 3, the user will right click on close button 316 in window 302. Alternatively, the menu can be brought up in other ways, for example, by right clicking at another location on the window to be locked, Menu 400 contains at least an option 402 to lock the window on which the clicked-on close button is located. For example, as shown in FIG. 4, option 402 may state “Lock Window”. Menu 400 may also contain other options, if desired, such as options 404 and 406 shown in FIG. 4.

To lock window 302 illustrated in FIG. 3, the user selects option 402 on menu 400 by, for example, left-clicking on option 402. Selecting option 402 locks window 302 against being closed by a single, user initiated closing action, for example, by simply clicking on close button 316 on window 302. The user may lock any one or all of windows 302, 304 and 306 displayed on display screen 300 by right-clicking on the close button of the desired window to display menu 402, and then selecting the “Lock Window” option on the menu.

If the user wishes to unlock a window after the window has been locked, the user right clicks on the close button for the locked window to again bring up menu 400. At this time, however, option 402 on menu 400 will state “Unlock Window”; and by clicking on that option, the user may unlock the window such that the window can again be closed by a single, user initiated closing action, for example, by clicking on the close button of the window.

In accordance with a preferred embodiment of the present invention, a second functionality is also provided in the data processing system for closing a locked window by a plurality of user initiated closing actions. The second functionality includes a pop-up box that appears on display screen 300, for example, when a user attempts to close a locked window by clicking on the close button for that window. FIG. 5 is a pictorial representation of a pop-up box that may appear on the display screen of FIG. 3 in accordance with a preferred embodiment of the invention The pop-up box is generally designated by reference number 500, and includes an inquiry message 502 asking the user to confirm his intention to close the window. A suitable inquiry message, for example, can be “Are you sure you want to close this window?“Pop-up box 500 may also include boxes 504 and 506 that are designated “Close” and “Cancel”. If the user does intend to close the window, he clicks on Close box 504 and the window is closed. If the user did not intend to close the window, for example, if close button 316 of window 302 was clicked on accidentally, or if the user has changed his mind about closing the window, the user clicks on Cancel box 506 and the window will remain open.

FIG. 6 is a flowchart that illustrates a method for locking a window against being closed by a single, user initiated closing action in accordance with a preferred embodiment of the present invention. The method is generally designated by reference number 600 and can be implemented, for example, as part of the operating system of data processing system 200 illustrated in FIG. 2. The method begins by a user right-clicking on the close button of a window displayed on a display screen (step 602). Right-clicking on the close button brings up a menu on the display screen (step 604). A user then selects an option on the menu to lock the window (step 606), and the window is locked against being closed by a single, user-initiated closing action (step 608).

FIG. 7 is a flowchart that illustrates a method for closing a locked window by a plurality of user initiated closing actions in accordance with a preferred embodiment of the present invention. The method is generally designated by reference number 700 and begins by a user left-clicking on the close button of the window to be closed (step 702). A pop-up box appears on the display screen requesting confirmation that the user wishes to close the window (step 704). If the user does intend to close the window (Yes output of step 704), the user confirms the intention to close the window (step 706) and the window is closed (step 708). If the user does not confirm his intention to close the window (No output of step 704), the window is not closed and remains open (step 710).

The present invention thus provides a method, system and computer program product for controlling the closing of a window on a display screen in a data processing system. A system for controlling the closing of a window includes a first functionality for locking a window against being closed by a single, user initiated closing action, and a second functionality for closing the locked window by a plurality of user initiated closing actions. Because a plurality of closing actions is required to close a locked window, the unintentional closing of a window is substantially prevented.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for controlling the closing of a window on a display screen in a data processing system, comprising:
first functionality for locking a window against being closed by a single, user-initiated closing action; and
second functionality for closing the locked window by a plurality of user initiated closing actions.

2. The system according to claim 1, wherein the first functionality includes functionality for displaying a menu that includes at least an option for locking the window against being closed by a single, user initiated closing action.

3. The system according to claim 2, wherein the first functionality includes functionality for displaying the menu in response to clicking on a location of the window.

4. The system according to claim 3, wherein the functionality for displaying the menu in response to clicking on a location of the window comprises functionality for displaying the menu in response to right-clicking on a location of the window.

5. The system according to claim 4, wherein the functionality for displaying the menu in response to right-clicking on a location of the window comprises functionality for displaying the menu in response to right-clicking on a close button on the window.

6. The system according to claim 2, wherein the first functionality further includes functionality for locking the window against being closed by a single, user initiated closing action upon selection of the option for locking the window from the menu.

7. The system according to claim 1, wherein the second functionality includes functionality for displaying a pop-up box on the display screen in response to a first closing action, the pop-up box including an inquiry message requesting confirmation of an intention to close the window.

8. The system according to claim 7,wherein the first closing action comprises clicking on a close button on the window.

9. The system according to claim 7, wherein the pop-up box further includes means for confirming the intention to close the window, and wherein the second functionality includes functionality for closing the window in response to a second closing action confirming the intention to close the window.

10. The system according to claim 9, wherein the pop-up box further includes means for canceling the closing of the window.

11. A method for controlling the closing of a window on a display screen in a data processing system, comprising:
receiving a user input selecting an option to lock a window against being closed by a single, user initiated closing action; and
locking the window against being closed by a single, user initiated closing action in response to receiving the user input.

12. The method according to claim 11, wherein selecting an option comprises right-clicking on a location of the window.

13. The method according to claim 12, wherein the right-clicking on a location of the window comprises right-clicking on a close button on the window.

14. The method according to claim 11, and further comprising:
receiving an input for a first closing action indicating an intention to close the locked window; and
receiving an input for a second closing action confirming the intention to close the locked window.

15. The method according to claim 14, wherein receiving an input for the first closing action comprises receiving an input from a user clicking on a close button of the window.

16. The method according to claim 15, wherein receiving an input for the first closing action brings up a pop-up box on the display screen requesting confirmation of the intention to close the window, and wherein receiving an input for the second closing action comprises receiving an input from a user confirming the intention to close the window.

17. The method according to claim 16, wherein confirming the intention to close the window comprises clicking on a button in the pop-up box.

18. A method for closing a window that has been locked against being closed by a single, user initiated closing action, comprising:
receiving an input for a first closing action indicating an intention to close the locked window; and
receiving an input for a second closing action confirming the intention to close the locked window.

19. A computer program product in a computer readable medium for controlling the closing of a window on a display screen in a data processing system, comprising:
first instructions providing a first functionality for locking a window against being closed by a single, user-initiated closing action; and
second instructions providing a second functionality for closing the locked window by a plurality of user initiated closing actions.

20. The computer program product according to claim 19, wherein the first instructions includes instructions for providing a functionality for displaying a menu that includes at least an option for locking the window against being closed by a single, user initiated closing action.

21. The computer program product according to claim 19, wherein the second instructions includes instructions for providing a functionality for displaying a pop-up box on the display screen in response to a first closing action, the pop-up box including an inquiry message requesting confirmation of an intention to close the window.
